(19) United States
(12) Patent Application Publication
(10) Pub. No.: US 2006/0174094 A1
(43) Pub. Date: Aug. 3, 2006

(54) Systems and methods for providing complementary operands to an ALU

(76) Inventors: Bryan Lloyd, Austin, TX (US); Wolfram M. Sauer, Nufringen (DE)

Correspondence Address: IBM CORPORATION (JSS);C/O SCHUBERT OSTERRIEDER & NICKELSON PLLC, 6013 CANNON MOUNTAIN DRIVE, S14, AUSTIN, TX, 78749, US

(21) Appl. No.: 11/049,342

(22) Filed: Feb. 2, 2005

(51) Int. Cl. G06F 9/44

(52) U.S. Cl. 712/226; 712/221

(57) ABSTRACT

Systems, methods and media for providing complementary operands to the arithmetic/logic unit of a processor are disclosed. A determination is made whether both a result of an instruction and a complement of that result are called for by a next instruction. If so, a value is input to a first ALU input and a complement of that value is input to a second input of the ALU, a carry in 1 is asserted, and the sum of the two inputs with the carry in 1 is computed.

### FIELD

The present invention is in the field of computer processor design. More particularly, the invention relates to providing complementary operands to an arithmetic/logic unit.

### BACKGROUND

Many different types of computing systems have attained widespread use around the world. These computing systems include personal computers, servers, mainframes and a wide variety of stand-alone and embedded computing devices. Sprawling client-server systems exist, with applications and information spread across many PC networks, mainframes and minicomputers. In a distributed system connected by networks, a user may access many application programs, databases, network systems, operating systems and mainframe applications. Computers provide individuals and businesses with a host of software applications including word processing, spreadsheet, accounting, e-mail, voice over Internet protocol telecommunications, and facsimile.

Users of digital processors such as computers continue to demand greater and greater performance from such systems for handling increasingly complex and difficult tasks. In addition, processing speed has increased much more quickly than that of main memory accesses. As a result, cache memories, or caches, are often used in many such systems to increase performance in a relatively cost-effective manner. Many modem computers also support “multi-tasking” or “multi-threading” in which two or more programs, or threads of programs, are run in alternation in the execution pipeline of the digital processor.

Modern computers include at least a first level cache L1 and typically a second level cache L2, for increasing the speed of memory access by the processor. This dual cache memory system enables storing frequently accessed data and instructions close to the execution units of the processor to minimize the time required to transmit data to and from memory. L1 cache is typically on the same chip as the execution units. L2 cache is external to the processor chip but physically close to it. Ideally, as the time for execution of an instruction nears, instructions and data are moved to the L2 cache from a more distant memory. When the time for executing the instruction is near imminent, the instruction and its data, if any, is advanced to the L1 cache.

A common architecture for high performance, single-chip microprocessors is the reduced instruction set computer (RISC) architecture characterized by a small simplified set of frequently used instructions for rapid execution. Thus, in a RISC architecture, a complex instruction comprises a small set of simple instructions that are executed in steps very rapidly. These steps are performed in execution units adapted to execute specific simple instructions. In a superscalar architecture, these execution units typically comprise load/store units, integer Arithmetic/Logic Units, floating point Arithmetic/Logic Units, and Graphical Logic Units that operate in parallel.

FIG. 1 shows a functional diagram of a computational data path that includes an Arithmetic/Logic Unit (ALU). The contents of registers RA 102 and RB 104 are received by an ALU 106. ALU 106 operates on the received operands from RA 102 and RB 104 according to the current instruction. For example, ALU 106 may add or subtract the two operands, or compute a logical function of the two operands such as A AND B. The result of the operation performed by ALU 106 is written to result register 108.

The registers RA 102 and RB 104 receive their contents through a selector or multiplexer 110 and 112, respectively. Each selector may choose between a result of the previous instruction from result register 108 or a value received from architectural memory 114. For example, consider the following instruction sequence:

ADD G0, G1, G2

SUBF G3, G0, G4

The first instruction says to add the contents of G1 and G2 and write the result into G0, where G0, G1, etc., are general purpose registers. The second instruction says to subtract G0 from G4 and write the result into G3. The subtract function SUBF is executed by the ALU as NOT(RA)+RB+carry in “1”. G4 is placed in register RB from a memory location. NOT(RA) is obtained from ALU 106. NOT(RA) can be computed in ALU 106 when it is required. The inverse will be computed when the ALU receives an invert control signal from invert control 116.

A problem arises for an instruction sequence such as the following:

ADD G0, G1, G2

SUBF G3, G0, G0

In this case the result of the ADD is needed for both inputs to ALU 106. The input from RA register 102 must be NOT(G0) and the input from RB register 104 must be G0. This is so because the subtraction function is performed by adding G0 to its complement with a carry in of ‘1’. But the bus that brings the result from result register 108 to RA 102 and RB 104 is shared. The bus cannot carry NOT(G0) and G0 at the same time. Nevertheless, inverting the ADD result in the ALU is highly preferable to performing the inversion in the multiplexing structure 110 and 112.

Thus, there is a need for a method and apparatus to overcome the problem of providing complementary operands to an ALU.

### SUMMARY

The problems identified above are in large part addressed by systems, methods and media for providing complementary operands to an arithmetic/logic unit (ALU). Embodiments implement a method for determining if an instruction calls for the arithmetic/logic unit to receive both a result of a previous instruction and a complement of the result of the previous instruction. If the instruction calls for both the result and the complement of the result of the previous instruction to be received by the arithmetic/logic unit, then a first value provides a first input to the arithmetic/logic unit, and a one's complement of the first value provides a second input to the arithmetic/logic unit. A carry in “1” is asserted in the arithmetic/logic unit so that a sum of the first and second inputs is zero.

One embodiment comprises an instruction interpreter that determines whether both a result and a complement of the result produced by an arithmetic/logic unit are called for as a first operand and a second operand by a next instruction to be executed by the arithmetic/logic unit. The embodiment comprises control circuitry to cause the first operand to be a first value and to cause the second operand to be a complement of the first value if the next instruction calls for the result and the complement of the result produced by the arithmetic/logic unit. An embodiment further comprises a complementation mechanism that causes the arithmetic/logic unit to produce the complement of the result if the instruction interpreter determines that the next instruction calls for the complement of the result as an operand. An embodiment further comprises a selector that selects between the result or complement of the result and a value obtained from a memory location.

### BRIEF DESCRIPTION OF THE DRAWINGS

Other objects and advantages of the invention will become apparent upon reading the following detailed description and upon reference to the accompanying drawings in which, like references may indicate similar elements:

FIG. 1 depicts a functional diagram of a computational data path that includes an Arithmetic/Logic Unit (ALU).

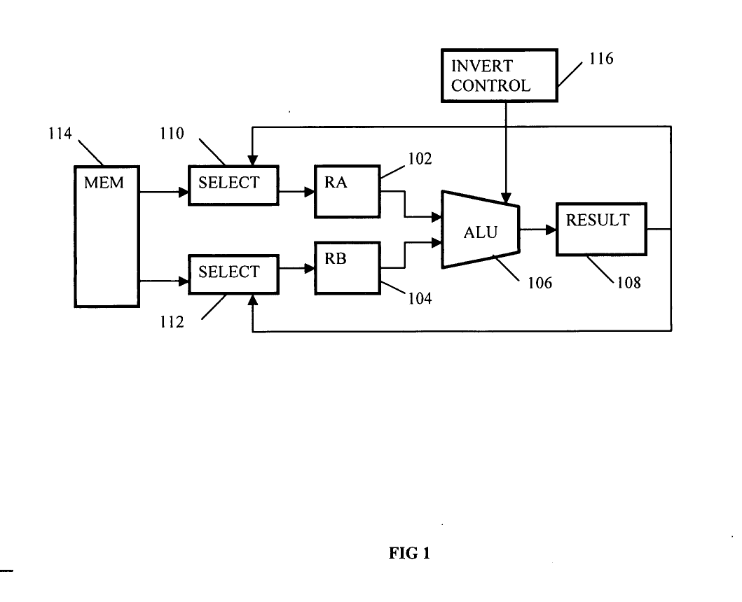

FIG. 2 depicts a digital system within a network; within the digital system is a multi-cycle processor.

FIG. 3 depicts an embodiment of a multi-cycle processor that can be implemented in a digital system such as shown in FIG. 2.

FIG. 4 depicts a functional diagram of a computational data path within a processor.

FIG. 5 depicts a flowchart of an embodiment for providing operands to an ALU.

### DETAILED DESCRIPTION OF EMBODIMENTS

The following is a detailed description of example embodiments of the invention depicted in the accompanying drawings. The example embodiments are in such detail as to clearly communicate the invention. However, the amount of detail offered is not intended to limit the anticipated variations of embodiments; but, on the contrary, the intention is to cover all modifications, equivalents, and alternatives falling within the spirit and scope of the present invention as defined by the appended claims. The detailed descriptions below are designed to make such embodiments obvious to a person of ordinary skill in the art.

In one embodiment, a computer processor comprises an arithmetic/logic unit that receives a first operand from a first register and a second operand from a second register and executes a first instruction by performing an operation on the first and second operands to produce a result. The processor further comprises an instruction interpreter that determines whether the result or a complement of the result produced by the arithmetic/logic unit is called for as an operand by a next instruction to be executed by the arithmetic/logic unit. The processor further comprises control circuitry to cause the first operand to be a first value and to cause the second operand to be a complement of the first value if the next instruction calls for the result and the complement of the result of the first instruction. The embodiment comprises a complementation mechanism to produce a complement of the result if the next instruction calls for the complement of the result as an operand. Embodiments further comprise a selector that selects between the result or complement of the result and a value obtained from a memory location that is not the result or complement of the result.

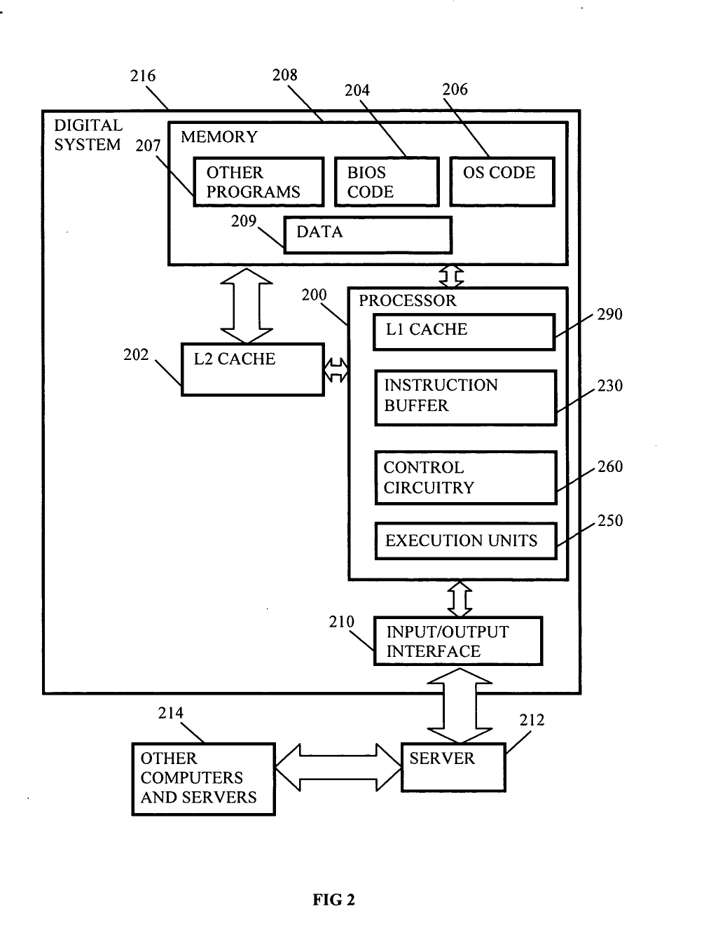

FIG. 2 shows a digital system 216 such as a computer or server implemented according to one embodiment of the present invention. Digital system 216 comprises a processor 200 that can operate according to BIOS Code 304 and Operating System (OS) Code 206. The BIOS and OS code is stored in memory 208. The BIOS code is typically stored on Read-Only Memory (ROM) and the OS code is typically stored on the hard drive of computer system 216. Memory 208 also stores other programs for execution by processor 200 and stores data 209 Digital system 216 comprises a level 2 (L2) cache 202 located physically close to multi-threading processor 200. Processor 200 comprises an on-board level one (L1) cache 290 and execution units 250 where instructions are executed.

Processor 200 comprises an on-chip level one (L1) cache 290, an instruction buffer 230, control circuitry 260, and execution units 250. Level 1 cache 290 receives and stores instructions that are near to time of execution. Instruction buffer 230 forms an instruction queue and enables control over the order of instructions issued to the execution units. Execution units 250 perform the operations called for by the instructions. Execution units 250 may comprise load/store units, integer Arithmetic/Logic Units, floating point Arithmetic/Logic Units, and Graphical Logic Units. Each execution unit comprises stages to perform steps in the execution of the instructions received from instruction buffer 230. Control circuitry 260 controls instruction buffer 230 and execution units 250. Control circuitry 260 also receives information relevant to control decisions from execution units 250. For example, control circuitry 260 is notified in the event of a data cache miss in the execution pipeline.

Digital system 216 also typically includes other components and subsystems not shown, such as: a Trusted Platform Module, memory controllers, random access memory (RAM), peripheral drivers, a system monitor, a keyboard, one or more flexible diskette drives, one or more removable non-volatile media drives such as a fixed disk hard drive, CD and DVD drives, a pointing device such as a mouse, and a network interface adapter, etc. Digital systems 116 may include personal computers, workstations, servers, mainframe computers, notebook or laptop computers, desktop computers, or the like. Processor 200 may also communicate with a server 212 by way of Input/Output Device 210. Server 212 connects system 216 with other computers and servers 214. Thus, digital system 216 may be in a network of computers such as the Internet and/or a local Intranet.

In one mode of operation of digital system 216, data and instructions expected to be processed in a particular order in the processor pipeline of processor 200 are received by the L2 cache 202 from memory 208. L2 cache 202 is fast memory located physically close to processor 300 to achieve greater speed. The L2 cache receives from memory 208 the instructions for a plurality of instruction threads that may be independent; that is, execution of an instruction of one thread does not first require execution of an instruction of another thread. The L1 cache 290 is located in processor 200 and contains data and instructions preferably received from L2 cache 202. Ideally, as the time approaches for a program instruction to be executed, it is passed with its data, if any, first to the L2 cache, and then as execution time is near imminent, the instruction is passed to the L1 cache 290.

Execution units 250 execute the instructions received from the L1 cache 290. Execution units 250 may comprise load/store units, integer Arithmetic/Logic Units, floating point Arithmetic/Logic Units, and Graphical Logic Units. Execution units 250 comprise stages to perform steps in the execution of instructions. Further, instructions can be submitted to different execution units for execution in parallel. Data processed by execution units 250 are storable in and accessible from integer register files and floating point register files. Data stored in these register files can also come from or be transferred to on-board L1 cache 290 or an external cache or memory.

An instruction can become stalled in its execution for a plurality of reasons. An instruction is stalled if its execution must be suspended or stopped. One cause of a stalled instruction is a cache miss. A cache miss occurs if, at the time for performing a step in the execution of an instruction, the data required for performing the step is not in the L1 cache. If a cache miss occurs, data can be received into the L1 cache directly from memory 108, bypassing the L2 cache. Accessing data in the event of a cache miss is a relatively slow process. When a cache miss occurs, an instruction cannot continue execution until the missing data is retrieved. While this first instruction is waiting, feeding other instructions to the pipeline for execution is desirable.

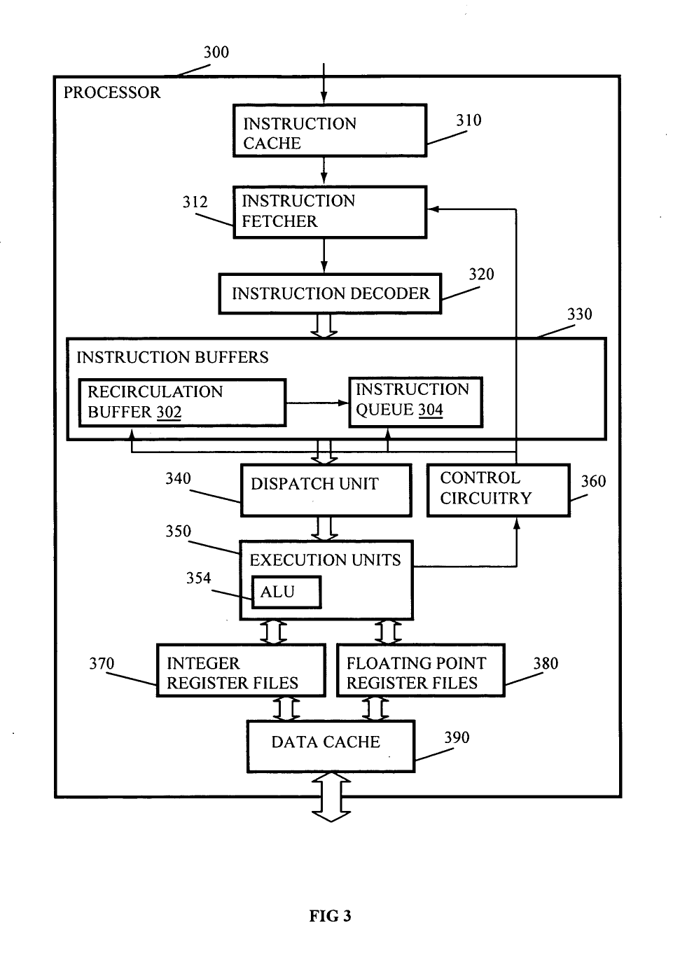

FIG. 3 shows an embodiment of a multi-cycle processor 300 that can be implemented in a digital system such as digital system 216. A level 1 instruction cache 310 receives instructions from memory external to the processor, such as a level 2 cache. In one embodiment, as instructions for different threads approach a time of execution, they are transferred from a more distant memory to an L2 cache. As time for execution of an instruction draws near, it is transferred from the L2 cache to the L1 instruction cache 310.

An instruction fetcher 312 maintains a program counter and fetches instructions from instruction cache 310. The program counter of instruction fetcher 312 may normally increment to point to the next sequential instruction to be executed, but in the case of a branch instruction, for example, the program counter can be set to point to a branch destination address to obtain the next instruction. In one embodiment, when a branch instruction is received and decoded, the processor 300 predicts whether the branch is taken. If the prediction is that the branch is taken, then instruction fetcher 312 fetches the instruction from the branch target address. If the prediction is that the branch is not taken, then instruction fetcher 312 fetches the next sequential instruction. If the prediction is wrong, then the pipeline must be flushed of instructions younger than the branch instruction.

An instruction decoder receives and decodes the instructions fetched by instruction fetcher 316. An instruction received into instruction decoder 320 typically comprises an OPcode, a destination address, a first operand address, and a second operand address:

| | | | |
|---|---|---|---|
| OPCODE | Destination Address | First Operand | Second Operand |
| | | Address | Address |

The OPcode is a binary number that indicates the arithmetic, logical, or other operation to be performed by the execution units 350. When an instruction is executed, the processor passes the OPcode to control circuitry that directs the appropriate one of execution units 350 to perform the operation indicated by the OPcode. The first operand address and second operand address locate the first and second operands in a memory data register. The destination address locates where to place the results in the memory data register.

Instruction buffer 330 receives the decoded instructions from instruction decoder 320. Instruction buffer 330 comprises memory locations for a plurality of instructions. Instruction buffer 330 may reorder the order of execution of instructions received from instruction decoder 320. Instruction buffer 330 thereby provides an instruction queue 304 to provide an order in which instructions are sent to a dispatch unit 340. For example, in a multi-threading processor, instruction buffer 330 may form an instruction queue that is a multiplex of instructions from different threads. Each thread can be selected according to control signals received from control circuitry 360. Thus, if an instruction of one thread becomes stalled in the pipeline, an instruction of a different thread can be placed in the pipeline while the first thread is stalled.

Instruction buffer 330 may also comprise a recirculation buffer to handle stalled instructions. If an instruction is stalled because of, for example, a data cache miss, the instruction can be stored in the recirculation buffer until the required data is retrieved. When the required data is received into a memory data register, the instruction is moved from the recirculation buffer to be dispatched by dispatch unit 340. This is faster than retrieving the instruction from the instruction cache.

Dispatch unit 340 dispatches the instructions received from instruction buffer 330 to execution units 350. Execution units 350 comprise stages to perform steps in the execution of instructions received from dispatch unit 340. Data processed by execution units 350 are storable in and accessible from integer register files 370 and floating point register files 380. Data stored in these register files can also come from or be transferred to an on-board data cache 390 or an external cache or memory. Each stage of execution units 350 is capable of performing a step in the execution of an instruction of a different thread. The instructions of threads can be submitted by dispatch unit 340 to execution units 350 in a preferential order. Execution units 450 may comprise load/store units, integer Arithmetic/Logic Units, floating point Arithmetic/Logic Units, and Graphical Logic Units. In particular execution units 350 comprise an Arithmetic Logic Unit (ALU) 354. ALU 354 comprises circuitry for performing arithmetic functions and logic functions.

In each cycle of operation of processor 300, execution of an instruction progresses to the next stage through the processor pipeline within execution units 350. Those skilled in the art will recognize that the stages of a processor “pipeline” may include other stages and circuitry not shown in FIG. 3. In a multi-threading processor, each stage can process a step in the execution of an instruction of a different thread. Thus, in a first cycle, processor stage 1 will perform a first step in the execution of an instruction of a first thread. In a second cycle, next subsequent to the first cycle, processor stage 2 will perform a next step in the execution of the instruction of the first thread. Also during the second cycle, processor stage 1 performs a first step in the execution of an instruction of a second thread. And so forth.

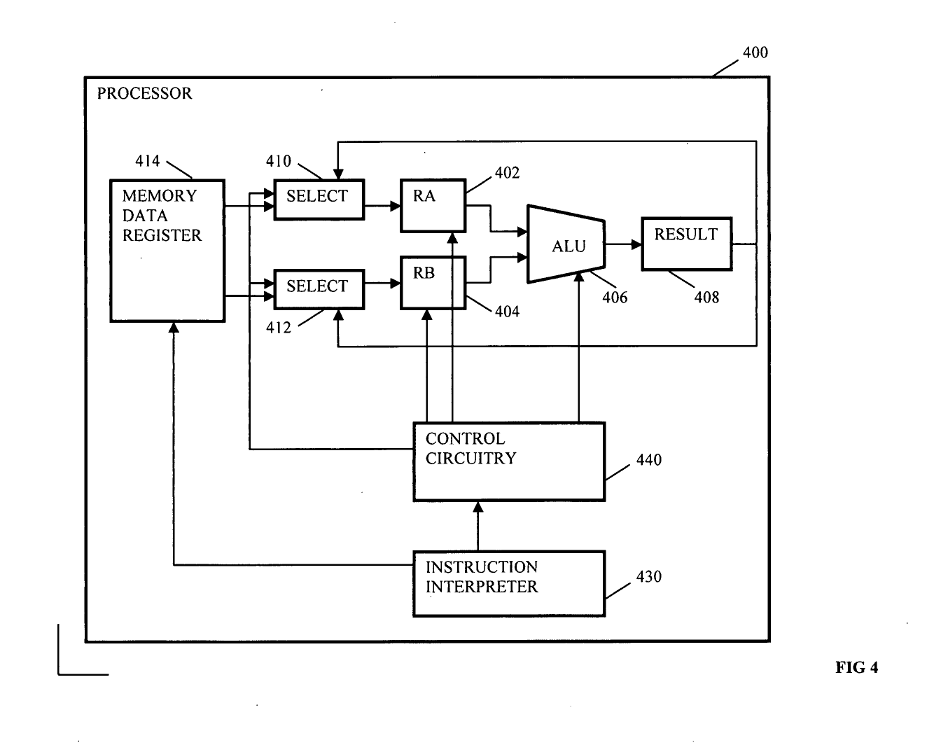

FIG. 4 shows a functional diagram of a computational data path within a processor 400. Processor 400 includes an ALU 406 with a controller 440 and instruction interpreter 430. Instruction interpreter 430 determines whether the ALU needs the result of the previous instruction and/or its complement for the next instruction to be executed. Two registers RA 402 and RB 404 provide the inputs received by ALU 406. The processor places the result of an operation performed by the ALU, or a complement of the result of the operation, in a result register 408. The processor places the result in result register 408 on a result bus that feeds back to selectors 410 and 412. Selector 410 selects between the result from register 408 and a value obtained from memory data register 414. Similarly, selector 412 selects between the result from result register 408 and a value obtained from memory data register 414.

As noted above, an instruction received into an instruction register 430 typically comprises an OPcode, a destination address, a first operand address, and a second operand address. The processor 400 passes the OPcode to control circuitry 440. Control circuitry 440 receives the OPcode and directs ALU 406 to perform the operation called for by the OPcode. The first operand address and second operand address locate the first and second operands in memory data register 414. The destination address locates where to place the results in memory data register 414. Thus, the first operand address addresses a location in memory data register 414 containing a value to input as the first operand to the ALU. Addressing the memory location enables the value to be written to selector 410. Selector 410 may select this value as the input to register RA 402. However, if the current instruction requires as its input the result of the previous instruction, selector 410 may select the output of result register 408 as the input to register RA 402. Moreover, if the current instruction requires as its input the complement of the result of the previous instruction, the instruction result is complemented in ALU 406 prior to transfer to the result bus.

The second operand address addresses a location in memory data register 414 containing a value to input as the second operand to the ALU. Addressing the memory location enables the value to be written to selector 412. Selector 412 may select this value as the input to register RB 404. However, if the current instruction requires as its input the result of the previous instruction, selector 412 may select the output of result register 408 as the input to register RB 404. Moreover, if the current instruction requires as its input the complement of the result of the previous instruction, the instruction result is complemented in ALU 406 prior to transfer to the result bus.

To further understand the embodiment of FIG. 4, consider the following instruction sequence:

ADD G0,G1,G2

ADD G3,G0,G0

Here the result of the first ADD provides both operands for the second ADD. This condition is detected by instruction interpreter 430. In response to this condition, control circuitry 440 does not invert the result of the first ADD obtained from result register 408 but places the result on the result bus. Selectors 410 and 412 are caused by control circuitry 440 to select the result bus for input to registers RA 402 and RB 404.

Next consider the following instruction sequence:

ADD G0,G1,G2

SUBF G3,G0,G4

The subtraction function, SUBF, requires as one of its operands the result of the ADD function. This condition is detected by instruction interpreter 430. The subtraction function is computed by asserting the one's complement of the result of the ADD function, G0, and adding it to G4 in the ALU with a carry in “1”. The ALU asserts the one's complement during execution of the previous instruction in response to a control signal from control circuitry 440. Control circuitry 440 generates this control signal when the complement of the result of an instruction is needed as an operand of the next instruction to perform a subtract, compare, trap or similar function. The processor asserts the carry in “1” during the current instruction in response to another control signal from control circuitry 440.

Thus, in this example, during the execution of the ADD function, the ALU computes the sum of the two operands and asserts the one's complement of the sum, which transfers to result register 408. During execution of the SUBF function, selector 410 selects as the input to register RA 402, the one's complement of the sum from result register 408. Also during execution of the SUBF function, the processor asserts a carry in “1” in the ALU, and the inputs from RA 402 and RB 404 are added.

Now consider the following instruction sequence:

ADD G0,G1,G2

SUBF G3,G0,G0

The subtraction function, SUBF, requires as one of its operands the result of the ADD function and requires as another of its operands the complement of the result of the ADD function. The result and its complement cannot be placed on the result bus at the same time. Thus, a mechanism is needed to present a value and its complement to the input of the ALU when the result of the previous instruction and its complement are called for as operands in the current instruction.

In this case, control circuitry 440 is provided to force 0xFFFFFFFFFFFFFFFF into register RA 402 and to force 0x0000000000000000 into register RB 404. Also, control circuitry 440 asserts or causes to be asserted a carry in “1” to ALU 406 and an ADD of the values in the two registers is executed. This ADD produces the result of “0,” which is the correct result of the subtraction function. Thus, if the instruction calls for both the result and the complement of the result of the previous instruction to be received and added by the arithmetic/logic unit, then a first value is input to the arithmetic/logic unit and the one's complement of the first value is input to the arithmetic/logic unit. Then, the processor asserts a carry in “1” in the arithmetic/logic unit so that a sum of the two inputs is zero.

Thus, one embodiment comprises an instruction interpreter that determines whether both a result and a complement of the result produced by an arithmetic/logic unit are called for as a first operand and a second operand by a next instruction to be executed by the arithmetic/logic unit. The embodiment comprises control circuitry to cause the first operand to be a first value and to cause the second operand to be a complement of the first value if the next instruction calls for the result and the complement of the result produced by the arithmetic/logic unit. An embodiment further comprises a complementation mechanism that causes the arithmetic/logic unit to produce the complement of the result if the instruction interpreter determines that the next instruction calls for the complement of the result as an operand. An embodiment further comprises a selector that selects between the result or complement of the result and a value obtained from a memory location.

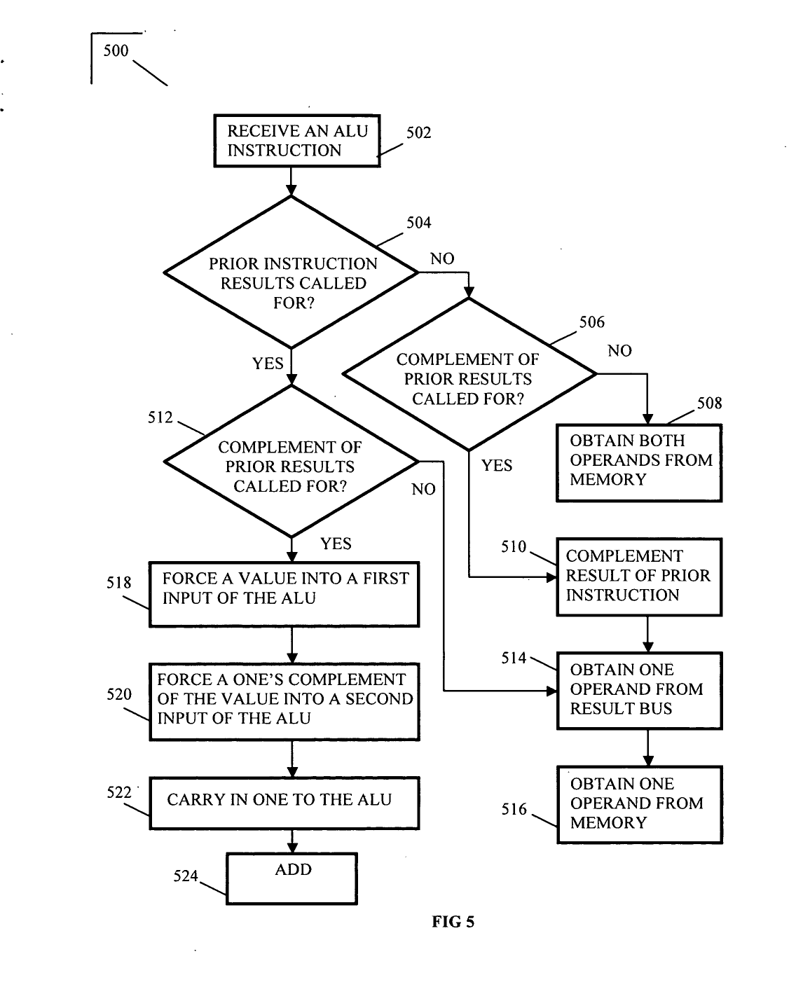

FIG. 5 shows a flowchart of one embodiment for providing operands to an ALU. In a first step, a processor receives an instruction to be executed by the ALU (element 502.) The processor then determines whether the present instruction calls for the result of the instruction that has just finished execution (element 504.) If not, the processor determines whether the present instruction calls for the complement of the result of the instruction that has just finished execution (element 506.) If not, the processor obtains both operands from memory and not from the result bus (element 508.) If the processor determines that the present instruction does call for the complement of the result of the previous instruction (element 506), then the result of the previous instruction is complemented (element 510) and placed on the result bus. Then, one operand is obtained from the result bus (element 514) and the other operand is obtained from memory and not the result bus (element 516.)

Returning to element 504, if the results of the prior instruction are called for by the present instruction, the processor determines if the complement of the result is also called for (element 512.) If not, then one operand is the result of the previous instruction obtained from the result bus (element 514) and the other operand is obtained from memory (element 516.) If the prior instruction result is called for (element 504) and the complement of that result is called for (element 512), then: a value is input to the first input of the ALU (element 518) and the one's complement of that value is input to the second input of the ALU (element 520.) A carry-in 1 is asserted in the ALU (element 522) which computes the sum of the two inputs (element 524.)

Thus, embodiments implement a method for determining if an instruction calls for the arithmetic/logic unit to receive both a result of a previous instruction and a complement of the result of the previous instruction. If the instruction calls for both the result and the complement of the result of the previous instruction to be received by the arithmetic/logic unit, then, a first value provides a first input to the arithmetic/logic unit, and a one's complement of the first value provides a second input to the arithmetic/logic unit. A carry in “1” is asserted in the arithmetic/logic unit so that a sum of the first and second inputs is zero.

Although the present invention and some of its advantages have been described in detail for some embodiments, it should be understood that various changes, substitutions and alterations can be made herein without departing from the spirit and scope of the invention as defined by the appended claims. Although an embodiment of the invention may achieve multiple objectives, not every embodiment falling within the scope of the attached claims will achieve every objective. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A computer processor, comprising:
an arithmetic/logic unit that receives a first operand from a first register and a second operand from a second register and executes a first instruction by performing an operation on the first and second operands to produce a result;
an instruction interpreter that determines whether the result or a complement of the result produced by the arithmetic/logic unit is called for as an operand by a next instruction to be executed by the arithmetic/logic unit;
a complementation mechanism to produce a complement of the result if the next instruction calls for the complement of the result as an operand;
a selector that selects between the result or complement of the result and a value obtained from a memory location that is not the result or complement of the result;
control circuitry to cause the first operand to be a first value and to cause the second operand to be a complement of the first value if the next instruction calls for the result and the complement of the result of the first instruction.

2. The computer processor of claim 1, further comprising an instruction buffer that provides instructions for execution by the arithmetic/logic unit.

3. The computer processor of claim 1, further comprising a recirculation buffer for storing an instruction that is stalled in a pipeline of the computer processor.

4. The computer processor of claim 1, further comprising a plurality of execution units that execute instructions in parallel and a dispatch unit that dispatches instructions to the arithmetic logic unit and to different ones of the plurality of execution units.

5. The computer processor of claim 1, further comprising an instruction fetcher that obtains instructions from a cache memory according to a value of a program counter.

6. The computer processor of claim 1, wherein the control circuitry comprises circuitry to cause the complementation mechanism to produce the complement of the result computed by the arithmetic/logic unit in response to a determination by the instruction interpreter that the complement of the result is required as an operand of the next instruction.

7. The computer processor of claim 1, wherein the control circuitry comprises circuitry to cause the operand in the first register to be the one's complement of zero, and to cause the operand in the second register to be zero, in response to a determination by the instruction interpreter that both the result and the complement of the result are called for as operands by the next instruction.

8. The computer processor of claim 1, wherein the control circuitry comprises circuitry to cause the selector to select the result or complement of the result if the next instruction calls for the result or the complement of the result, but not both, as an operand.

9. The computer processor of claim 1, wherein the control circuitry comprises circuitry to cause the selector to select a value from memory if at least one operand called for by the next instruction is not the result or complement of the result of the first instruction.

10. An apparatus for providing complementary operands as first and second operands to an arithmetic logic unit, comprising:
an instruction interpreter that determines whether both a result and a complement of the result produced by the arithmetic/logic unit are called for as a first operand and a second operand by a next instruction to be executed by the arithmetic/logic unit; and
control circuitry to cause the first operand to be a first value and to cause the second operand to be a complement of the first value if the next instruction calls for the result and the complement of the result produced by the arithmetic/logic unit.

11. The apparatus of claim 10, further comprising a complementation mechanism that causes the arithmetic/logic unit to produce the complement of the result if the instruction interpreter determines that the next instruction calls for the complement of the result as an operand.

12. The apparatus of claim 10, further comprising a selector that selects between the result or complement of the result and a value obtained from a memory location that is not the result or complement of the result.

13. The apparatus of claim 10, further comprising a recirculation buffer for storing an instruction that is stalled in a pipeline of the computer processor.

14. The apparatus of claim 10, further comprising a plurality of execution units that execute instructions in parallel and a dispatch unit that dispatches instructions to the arithmetic logic unit and to different ones of the plurality of execution units.

15. The apparatus of claim 10, wherein the control circuitry comprises circuitry to cause the operand in the first register to be the one's complement of zero, and to cause the operand in the second register to be zero, in response to a determination by the instruction interpreter that both the result and the complement of the result are called for as operands by the next instruction.

16. The apparatus of claim 10, wherein the control circuitry comprises circuitry to cause the selector to select the result or complement of the result if the next instruction calls for the result or the complement of the result, but not both, as an operand.

17. The apparatus of claim 10, wherein the control circuitry comprises circuitry to cause the selector to select a value from memory if at least one operand called for by the next instruction is not the result or complement of the result of the first instruction.

18. A method for providing complementary inputs to an arithmetic/logic unit, comprising:
determining if an instruction calls for the arithmetic/logic unit to receive both a result of a previous instruction and a complement of the result of the previous instruction; and
if the instruction calls for both the result and the complement of the result of the previous instruction to be received by the arithmetic/logic unit, then:
inputting a first value to a first input of the arithmetic/logic unit;
inputting a one's complement of the first value to a second input of the arithmetic/logic unit; and
asserting a carry in “1” in the arithmetic/logic unit so that a sum of the first and second inputs is zero.

19. The method of claim 18, further comprising obtaining from the output of the arithmetic/logic unit a first value to be input to the arithmetic/logic unit and obtaining from memory a second value to be input to the arithmetic/logic unit if the instruction calls for a result of the previous instruction to be received by the arithmetic/logic unit.

20. The method of claim 18, further comprising obtaining from the output of the arithmetic/logic unit a complement of a first value to be input to the arithmetic/logic unit and obtaining from memory a second value to be input to the arithmetic/logic unit, if the instruction calls for a complement of a result of the previous instruction to be received by the arithmetic/logic unit.
